(19) United States
(12) Patent Application Publication
(10) Pub. No.: US 2012/0144124 A1
(43) Pub. Date: Jun. 7, 2012

(54) METHOD AND APPARATUS FOR MEMORY ACCESS UNITS INTERACTION AND OPTIMIZED MEMORY SCHEDULING

(75) Inventors: Kevin M. Lepak, Austin, TX (US); Benjamin Tsien, Fremont, CA (US); Todd Rafacz, Austin, TX (US)

(73) Assignee: ADVANCED MICRO DEVICES, INC., Sunnyvale, CA (US)

(21) Appl. No.: 12/962,042

(22) Filed: Dec. 7, 2010

(51) Int. Cl. G06F 12/08

(52) U.S. Cl. 711/137; 711/E12.057

(57) ABSTRACT

A method and an apparatus for modulating the prefetch training of a memory-side prefetch unit (MS-PFU) are described. An MS-PFU trains on memory access requests it receives from processors and their processor-side prefetch units (PS-PFUs). In the method and apparatus, an MS-PFU modulates its training based on one or more of a PS-PFU memory access request, a PS-PFU memory access request type, memory utilization, or the accuracy of MS-PFU prefetch requests.

### FIELD OF INVENTION

This application is related to processor technology and, in particular, prefetching.

### BACKGROUND

FIG. 1 shows a block diagram of a multi-processor system 100, having a variety of processors 110_{A-D}, (collectively hereinafter referred to by the numeral alone). The processors 110 comprise digital logic circuitry that perform computations needed for the computer system 100 to operate. These computations include additions, subtractions, conjunctions, shifts and rotates and many other computations that modern processors can perform on data values. When put together collectively, these computations performed by the processors 110 enable the computer system 100 to operate, for example causing a word processing program to run, or allowing a liquid crystal display (LCD) screen to display images. The processors 110 may be single-core or multi-core processors. The processors 110 may also be interconnected by HyperTransport™ technology.

The processors 110 may be any one of a variety of processors such as a Central Processing Unit (CPU) or a Graphics Processing Unit (GPU). For instance, they may be x86 microprocessors that implement x86 64-bit instruction set architecture and are used in desktops, laptops, servers, and superscalar computers, or they may be Advanced RISC (Reduced Instruction Set Computer) Machines (ARM) processors that are used in mobile phones or digital media players. Other embodiments of the processors are contemplated, such as Digital Signal Processors (DSP) that are particularly useful in the processing and implementation of algorithms related to digital signals, such as voice data and communication signals, and microcontrollers that are useful in consumer applications, such as printers and copy machines.

Processors 110 are primarily computational engines, and thus generally do not have a large amount of data storage space or memory within them. For example, processors 110 may be provided with relatively small “on-site” storage locations, also called caches 130_{A-D}, (collectively hereinafter referred to by the numeral alone), where a limited amount of memory data is stored for ease of access by a processor 110. Caches 130 are typically used to store data associated with a program in current use. Processors 110 may have a hierarchy of caches 130, where a Level 1 (L1) cache is the most readily available with the smallest memory access latency. To make the L1 cache readily available, it may share the processor's chip, and therefore, be an on-die cache, as is it is commonly referred to in silicon design.

Due to processor hardware and software design considerations, however, caches are typically not very large. Some processors may have, for example, a 128 kilobyte (KB) L1 cache size. A processor may also be equipped with a second level of cache, Level 2 (L2), which may be, for example, between 0.5 Mega Bytes (MB) and 8 MB. L2 cache designs are also constrained by hardware and software considerations. Although they are larger than L1 caches, there is a higher amount of memory access latency associated with them. Some processors are equipped with an additional higher layer cache, Level 3 (L3), which may be larger in size than either an L1 or L2, cache but it is likely to be slower in terms of memory access.

Because processors 110 have a limited amount of data storage space or memory within them, they rely on obtaining data needed for their computations from a system memory 170 by dispatching requests for data needed, and then after operating on data, sending the results back to system memory 170 to be stored. Therefore, when a processor 110 is in operation, there is continuous dispatching and sending of data from the processor 110 to system memory 170.

To facilitate a processor's 110 access to the system memory 170, a multi-processor system 100 typically includes a memory controller 140 that serves as a gateway for access to system memory 170. The memory controller 140 has a scheduler 160 (or a scheduling unit) that is responsible for managing access to the system memory 170. Multiple processors 110 may simultaneously request data from system memory 170. Since the scheduler 160 sees traffic entering and exiting the system memory 170, it is thus informed about how busy the system memory 170 has been, its bandwidth usage, and its available memory access resources, and may regulate access to the system memory 170.

Processors 110 generally run on a relatively fast frequency clock and therefore have short clock cycles, which in turn translates into fast execution of computational tasks. However, the speed at which a processor 110 can obtain data from the system memory 170 or write data to the system memory 170 is typically slower than its clock cycle, and therefore slower than the speed at which a processor 110 can perform computations on the data. For example, a request for data from the system memory 170 by a processor 110 will travel through a processor bus 180 to the memory controller 140. Within the memory controller 140, the request will await action by the scheduler 160 before being dispatched through a memory bus 190 to the system memory 170, and then the requested data will travel back through a similar path to a processor 110. This latency between the computation speed of a processor 110 and its memory access speed (which may be in the order of tens of thousands of clock cycles if the memory sought to be accessed is in a hard disk or a magnetic disk) will generally slow the performance of a processor 110.

### SUMMARY OF EMBODIMENTS

Embodiments of a method and apparatus for handling memory access interaction between a processor and a memory-side prefetch unit (MS-PFU) is provided. In the method and apparatus, a second memory access unit trains using a memory access request from a first memory access unit based on memory utilization. Further, in the method and apparatus, the first memory access request is received from a first memory access unit and information relating to memory utilization is also received.

In one embodiment, a first memory access request type is also received, wherein the first memory access request type corresponds to the first memory access request and it is determined whether to utilize the first memory access request type in training a second memory access unit based on the first memory access request type. In another embodiment, it is determined whether the first memory access request matches an existing training entry of the second memory access unit and it is also determined whether to utilize the first memory access request type in training a second memory access unit based on whether the first memory access request matches an existing training entry of the second memory access unit.

In other yet another embodiment of the method and apparatus, information regarding second memory access unit memory access request accuracy is received and is it determined whether to utilize the first memory access request in training a second memory access unit based on second memory access unit memory access request accuracy. In another embodiment, information regarding second memory access unit memory access request accuracy is received and it is determined whether to utilize the first memory access request type in training a second memory access unit based on second memory access unit memory access request accuracy.

### BRIEF DESCRIPTION OF THE DRAWINGS

A more detailed understanding may be had from the following description, given by way of example in conjunction with the accompanying drawings wherein:

FIG. 1 is a block diagram of a multi-processor system;

FIG. 2 shows an example of the latency for memory access requests issued by a processor;

FIG. 3 is a block diagram of a memory controller in connection with system memory;

FIG. 4 is a flow diagram of MS-PFU behavior modification according to an embodiment;

FIG. 5 shows a memory access request and its associated label from a processor to a memory controller; and

FIG. 6 is a flow diagram of a method for MS-PFU behavior modification utilizing memory access type according to an embodiment.

FIG. 7 is a flow diagram of a method for MS-PFU behavior modification utilizing memory access type and whether a matching data bank entry is present according to an embodiment.

FIG. 8 is a flow diagram of a method for MS-PFU behavior modification utilizing memory access type and MS-PFU prefetch accuracy according to an embodiment.

### DETAILED DESCRIPTION OF PREFERRED EMBODIMENTS

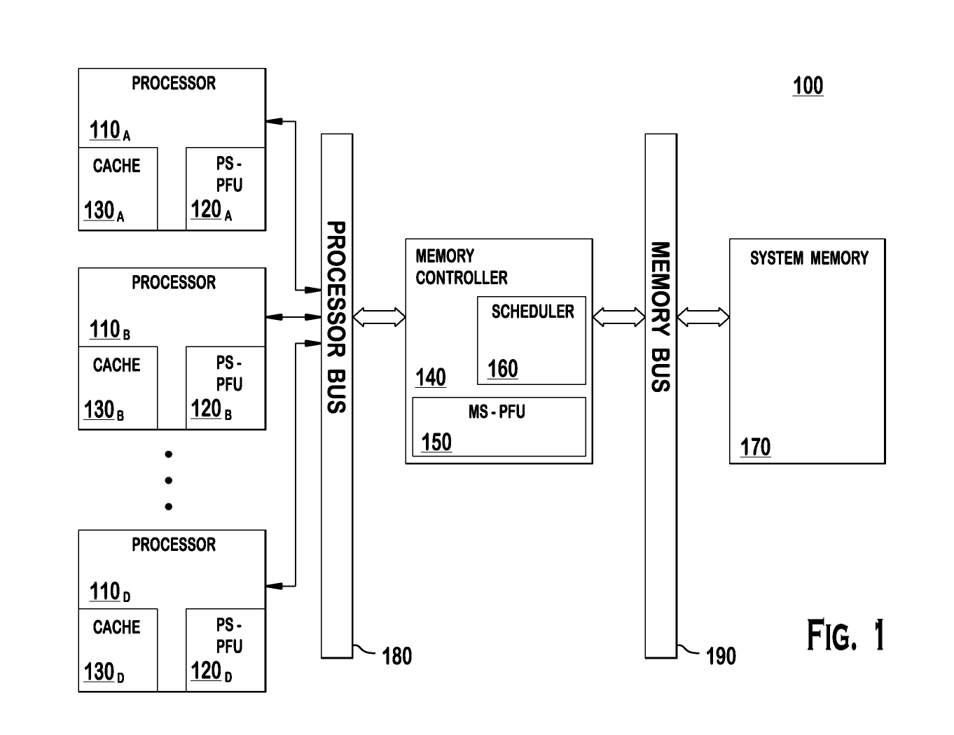

A processor 110, as seen in FIG. 1, makes two types of requests for data from the system memory 170: 1) demand requests; and 2) prefetch requests. When a processor 110 is in operation and seeks a data value from a memory address, a processor 110 will check its caches 130 to determine whether the needed data is present. If the data is not present in the caches 130, (meaning that there is a cache “miss”), then a processor 110 will issue a demand request for the data. Because the speed at which a processor 110 can obtain data from the system memory 170 is slower than the speed at which a processor 110 can perform computations on the data, a processor 110 may experience memory access latency before receiving the requested data.

To mitigate the memory access latency that arises when demand requests are made, a processor 110 also makes the second type of memory access requests; prefetch requests. Prefetching is a mechanism by which a processor 110 brings memory data, (e.g., data stored in the system memory 170), to its local storage locations, such as caches 130, ahead of its likely need by a processor 110. A processor 110 performs prefetching by using a prefetch unit (PFU). As shown in FIG. 1, processors 110 contain processor-side PFUs (PS-PFUs) 120_{A-D} (collectively hereinafter referred to by the numeral alone).

A PS-PFU 120 relies on prefetching algorithms and techniques to predict future memory data needs based on the memory data used in the past by a processor 110. For example, data in the system memory 170 may be organized into separate regions, and is referenced by addresses within those regions. Often, when a processor 110 requests data within a certain memory address, it is very likely that the next request will be for data in nearby addresses. Accordingly, a prefetching algorithm that prefetches data in nearby addresses may be useful in mitigating memory access latency.

There are many prefetching algorithms that are well known to those skilled in the art, which capture various memory access patterns and use these patterns in a variety of ways to predict future memory access behavior and prefetch data. A PS-PFU 120 may use any number of prefetch algorithms, either alone or in combination, to accomplish its prefetching needs. Prefetching is speculative, as there is no guarantee that the prefetched memory data will, in fact, be used by a processor 110.

To better manage its prefetching behavior, a processor 110 may associate a level of confidence with its prefetch requests from the system memory 170. For instance, a prefetch request may be considered a high confidence prefetch request, indicating that there is a high probability the prefetch will be useful to the processor 110 in accomplishing its computing needs. A prefetch request may, alternatively, be considered a medium confidence prefetch request, indicating a medium confidence that the prefetch request will be useful. Further, a processor 110 may assign a confidence level to the algorithms themselves. For instance, prefetch requests that result from certain prefetch algorithms may be associated with high or medium confidence depending on the type of algorithm. It may be said, however, that demand requests are the highest of confidence of memory access requests because, unlike prefetch requests which are speculative, demand requests represent a need for data by a processor 110 and their usefulness to the processor 110 is almost certain.

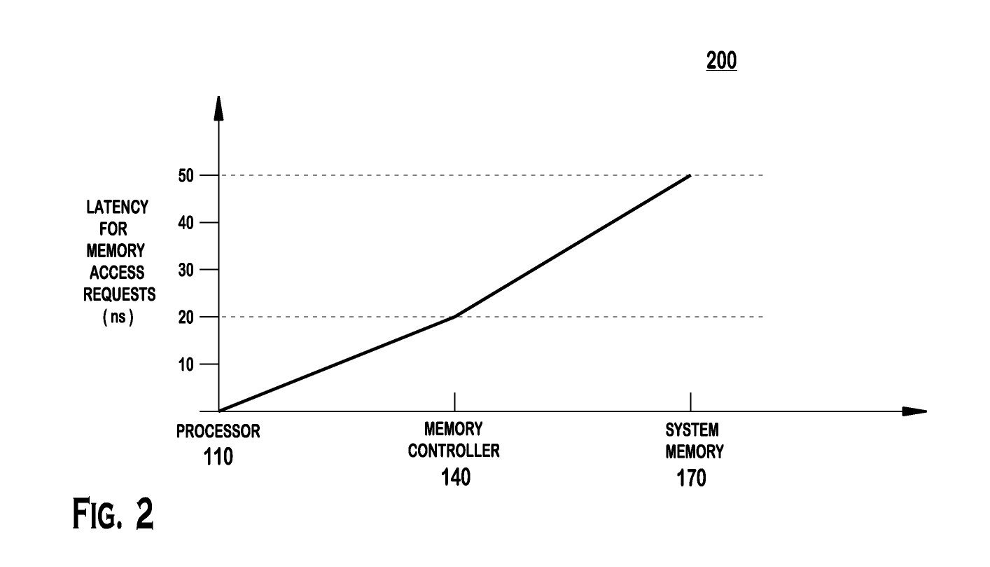

Prefetching may be done not only by the processors 110, but also by the memory controller 140. As shown in FIG. 1, the memory controller 140 contains a memory-side PFU (MS-PFU) 150. The MS-PFU 150 prefetches data from the system memory 170 and holds it in memory locations close to the memory controller 140, ahead of its recall by the processors 110. Prefetching by the MS-PFU 150 is another means of reducing memory access latency, since latency exists from the both the processors 110 to the memory controller 140, and from the memory controller 140 to the system memory 170. Shown in FIG. 2 is an example of the memory access latency experienced by a processor 110 in accessing memory data. A processor 110 experiences 50 nanoseconds (ns) of latency in obtaining data from system memory 170. However, only 20 ns of the latency is due to latency between a processor 110 and the memory controller 140; 30 ns is due to the latency between the memory controller 140 and the system memory 170. Therefore, prefetching by the memory controller 140 can further reduce the latency in a processor 110 in obtaining data from the memory system 170, (in the example shown in FIG. 2, this reduction is 30 ns).

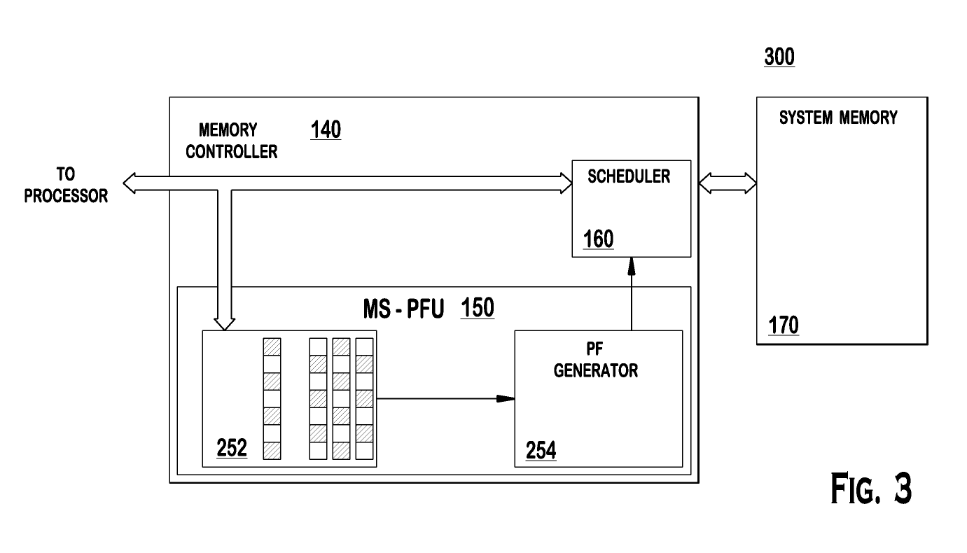

FIG. 3 is a block diagram of the memory controller 140, which contains the scheduler 160 and an MS-PFU 150. The scheduler 160 is responsible for managing access to the system memory 170, and also maintains information regarding system memory bandwidth utilization and metrics regarding how heavily the system memory 170 is being accessed. In some embodiments, memory utilization may be determined, or measured, as a percentage of utilized memory bandwidth to peak memory bandwidth. For instance, if the system memory at hand is Double Data Rate 3 Dynamic Random Access Memory (DDR3-DRAM) with two 64-bit channels and 1600 Mega Transfers per second, then the peak bandwidth is 25.6 Giga Bytes (GB) per second (2 channels*8 Bytes/channel/transfer*1.6G transfers/second). Memory utilization of over 60% may be considered high, whereas memory utilization between 30% to 60% may be considered medium, and memory utilization of below 30% may be consider low. Very high utilization may be considered to be above 90%.

Alternatively, in other embodiments, memory utilization may be measured by the number of memory access requests in a system memory scheduling queue (not shown). For instance, if system memory 170 comprises Double Data Rate 3 Dynamic Random Access Memory (DDR3-DRAM) with two channels and a capability to perform 1600 Mega Transfers per second (MT/s); if every channel can transfer 64 bits (8 Bytes) for a total of 16-Byte transfer capability of the DRAM and a memory access request pertains to 64 Bytes of data, then a memory access request will require four DDR3-DRAM transfers to complete the request or 2.5 ns, (calculated as 4*1/(1600 MHz)). Therefore, depending on whether a memory access request waits in a scheduling queue and on time delay parameter and specifications of the DRAM, memory utilization may be measured by the number of requests present in a memory scheduling queue. Benchmarks may be set for the number of memory access requests present in a scheduling queue where, for instance, 9 requests or more indicates high utilization, 6 to 8 requests indicate medium utilization and 5 or less requests indicates low utilization.

Whereas processor prefetch units, such as PS-PFU 120 in FIG. 1, prefetch based on their own processor's 110 memory data needs, a memory controller 140 does not in general have memory data needs as do processors 110. However, prefetching by the memory controller's 140 MS-PFU 150 is useful in reducing memory access latency, as described above. Further, prefetching by a MS-PFU 150 should be based on processor 110 memory data needs for it to be useful to the processors 110. To be useful to a processor 110 an MS-PFU 150 prefetch request needs to later satisfy one of the processor's 110 two types of memory access requests: demand request and prefetch requests.

The manner in which the MS-PFU 150 accomplishes prefetching is as follows: the MS-PFU 150 keeps a data bank 252 of memory access requests that the memory controller 140 receives from the processors 110. Data bank 252 may, for instance, comprise 32 regions, (each of which is 4 kB in size), where addresses of memory data requested by the processors 110 are placed. Data bank 252 may also contain patterns of memory access behavior by processors 110; (for example, a record of memory access requests of the processors). The prefetch (PF) generator 254 applies one or more prefetching algorithms to the information in data bank 252, and then issues prefetch requests to the scheduler 160.

If an MS-PFU 150 observes a memory access request from a processor 110, two alternatives are in order. The memory access request by the processor may be already present in the data bank 252 or the memory access request may not be present in the data bank 252. If the memory access request is not already present in the data bank 252, the MS-PFU 150 may either replace an already existing data bank 252 value with the new request or not include the request which is, in essence, ignoring the request. The replacement is important to keep the contents of the memory data bank 252 current to the needs of the processors 110. Various replacement schemes may be used that are well known in the art, such as Least Recently Used (LRU), however an MS-PFU 150 has to determine whether to replace an existing request with the new request.

Those skilled in the art will recognize that if data bank 252 is updated frequently, by allowing new processor memory access requests or patterns to replace existing requests or patterns, then the PF generator 254 will likely generate a relatively high number of prefetch requests, since prefetch algorithms are predictive based on the data they train on, or the data they are fed. As the data in data bank 252 that the PF generator 254 trains on changes, the number of prefetches generated will increase. However, if the memory addresses of data bank 252 are updated less frequently, then the prefetch algorithms used by PF generator 254 will likely not result in as many new prefetch requests because there has not been a change in the data the PF generator 254 trains on. The number of prefetch requests issued by the PF generator 254 positively correlates to how frequently the data bank 252 is updated; the more frequently the data bank 252 is updated, the more prefetch requests from MS-PFU 150 will result.

If the data bank 252 is consistently updated when the processors 110 are active in issuing demand and prefetch requests, prefetching by MS-PFU 150 will increase. This may lead to oversubscribing the system memory 170 because MS-PFU's 150 memory utilization is increasing at the same time that the processors 110 are utilizing the system memory due to their own memory access requests. Therefore, regulating prefetching by an MS-PFU 150 is important in managing the system memory 170 utilization.

The processors 110, on the other hand, generally do not reduce their demand requests, even when the system memory 170 utilization is high. Additionally, while the processors 110 may aim to reduce prefetch requests by the PS-PFUs 120 when the system memory 170 utilization is high, their ability to do so effectively may be somewhat limited. When information regarding the system memory 170 utilization is conveyed to the processors 110 so that they may adjust their prefetch behavior according to the availability of the system memory 170 resources, in many computer systems, and particularly multi-processor systems like multi-processor system 100 as seen in FIG. 1, this conveyed information about the system memory 170 utilization may not be timely. Those skilled in the art will recognize that in a multiprocessor system, processors 110 may occupy different sockets, and the memory controller 140 and the system memory 170 may also occupy different sockets. This may lead to a communication latency whereby the processors 110 and their PS-PFUs 120 may not have real-time information about current memory utilization, and thus may not be able to effectively adjust their prefetching behavior according to the availability of the system memory 170 resources.

Other than the effect of MS-PFU 150 prefetching on system memory utilization, it is important to consider how speculative the prefetching is by MS-PFU 150. MF-PFU 150 will generate more speculative prefetches when training or updating its data bank 252 with processor 110 PS-PFU 120 prefetch requests than when updating its data bank 252 with processor demand requests. This is because in the first event, the MS-PFU 150 is training on processor prefetch requests, which are by nature speculative, and prefetching based on speculative data will likely generate more speculative prefetching. Whereas, processor 110 demand requests are not speculative. Therefore, if demand requests and prefetch requests of the processors 110 are treated evenly in updating the data bank 252, this may lead to more speculative prefetching by the MS-PFU 150. For instance, if both demand requests and prefetch requests by the processors 110 are used in updating entries of data bank 252, then the prefetch requests generated by PF generator 254 will be more speculative than if prefetch requests by the processors 110 are not used in updating the entries of data bank 252, and only demand requests are used.

If demand and prefetch requests from the processors 110 are consistently and indiscriminately used to update the entries in the data bank 252, the MS-PFU 150 may contribute to over-subscribing the system memory 170, while at the same issuing prefetch requests that are relatively highly speculative and are less likely to be eventually useful to the processors 110. Without a method to modulate its behavior based on memory utilization, the MS-PFU 150 will increase prefetching in exactly those circumstances where it is desirable for it to prefetch less due to the high usage of the system memory 170, and may exacerbate the over-subscription of the system memory 170 with unduly speculative prefetch requests.

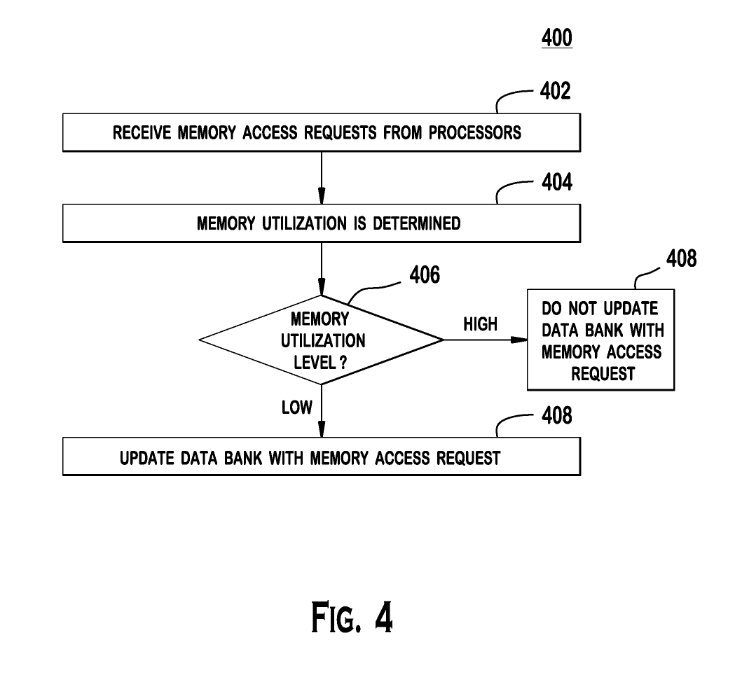

FIG. 4 is a flow diagram of a method 400 that the MS-PFU 150 implements to modulate its behavior based on memory utilization. In the method 400, MS-PFU 150 receives information 402 about memory access requests made by the processors 110 and receives information about the system memory 170 utilization from the scheduler 160 404. It is then determined whether the system memory 170 utilization level is high or low 406. If memory utilization is high, or little memory bandwidth is not used, then the data bank 252 is not updated with the received memory access request 408 so as not to generate additional prefetch requests by MS-PFU 150 when memory utilization is high. However, if memory utilization is low then the data bank 252 is updated with the received memory access request 410, so more prefetch requests will be issued by the MS-PFU 150. It should be noted that although method 400 is described as having a determination of either a high memory utilization level or a low memory utilization level, there may, in an alternative embodiment, be various degradations of memory utilization levels where as the memory utilization level increases, the data bank 252 is updated less frequently.

The MS-PFU 150 can modulate its prefetch behavior even further by considering both the type of memory access request, (demand or prefetch), and the confidence level, (the likelihood of usefulness), of the memory access request being made by a processor 110 in determining whether to update the data bank 252 with the request. Demand requests, in most embodiments, are associated with the highest level of confidence and generally have a higher level of confidence than any type of prefetch request. As described earlier, in some embodiments, a prefetch request may be considered a high, medium, or low confidence prefetch request depending on the probability that the prefetch will be useful to the processor 110 in accomplishing its computing needs. Other embodiments of the usefulness of a memory access request may also be contemplated.

A prefetch request may also be associated with a confidence level depending upon the prefetch algorithm that resulted in the prefetch request. For instance, stride-based algorithms and region-based algorithms are two prefetch algorithms that are well-known in the art. If a processor 110 associates a high confidence level with the stride-based algorithm and associates a medium confidence level with the region-based algorithm, then a processor 110 may associate a corresponding confidence level with the prefetch requests generated by these algorithms.

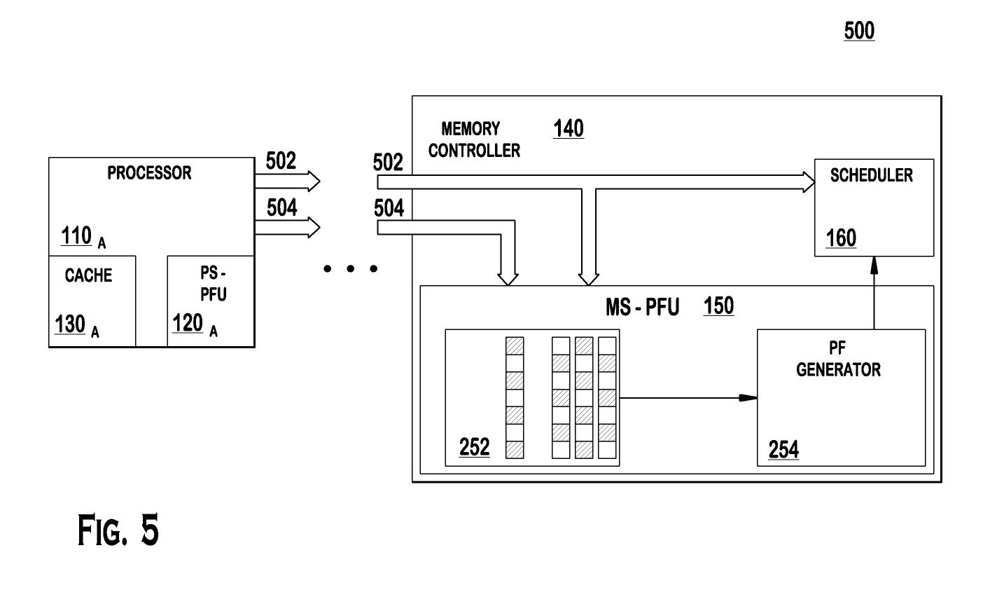

As illustrated in FIG. 5, a processor 110 may label 504 its memory access requests 502 as either “demand” or “prefetch”. Further, the label 504 may include a confidence level associated with the request 502. A processor 110 may provide this label 504 to the memory controller 140 for use by the MS-PFU 150 in determining whether to update the data bank 252. Shown in Table 1 is a 2-bit label 504 that a processor 110 may use in labeling its memory access request 502. As determined from Table 1, a request labeled as [x1] is interpreted to be a demand request, whereas a request labeled as [00] is interpreted to be a high confidence prefetch request and a request labeled as [10] is interpreted as a medium confidence prefetch request. Although Table 1 shows two levels of confidence, varying levels of confidence may be utilized in alternative embodiments.

TABLE 1
2-bit indicator of memory access request type

| Bit | Request Type | Prefetch Confidence |
|---|---|---|
| [0] | 0: Prefetch | See Bit [1] |
| | 1: Demand | N/A |
| [1] | 0: Prefetch—“Stride-based” | High |
| | 1: Prefetch—“Region-based” | Medium |

In the embodiment of FIG. 5, since the label 504 provided to the memory controller 140 indicates the type and confidence level of the memory access request 502 issued by a processor 110, the MS-PFU 150 can further modulate its behavior based on memory utilization. As described earlier, an MS-PFU 150 will generate more speculative prefetch requests if data bank 252 is updated with high confidence prefetch requests than if it is updated with demand requests. Likewise, an MS-PFU 150 will generate even more speculative prefetch requests if data bank 252 is updated with medium confidence prefetch requests than if it is updated with high confidence prefetch requests. Therefore, it is advantageous for an MS-PFU 150 to consider the type and confidence level of a memory access request 502 from a processor 110 in determining whether the request 502 should be used to update data bank 252.

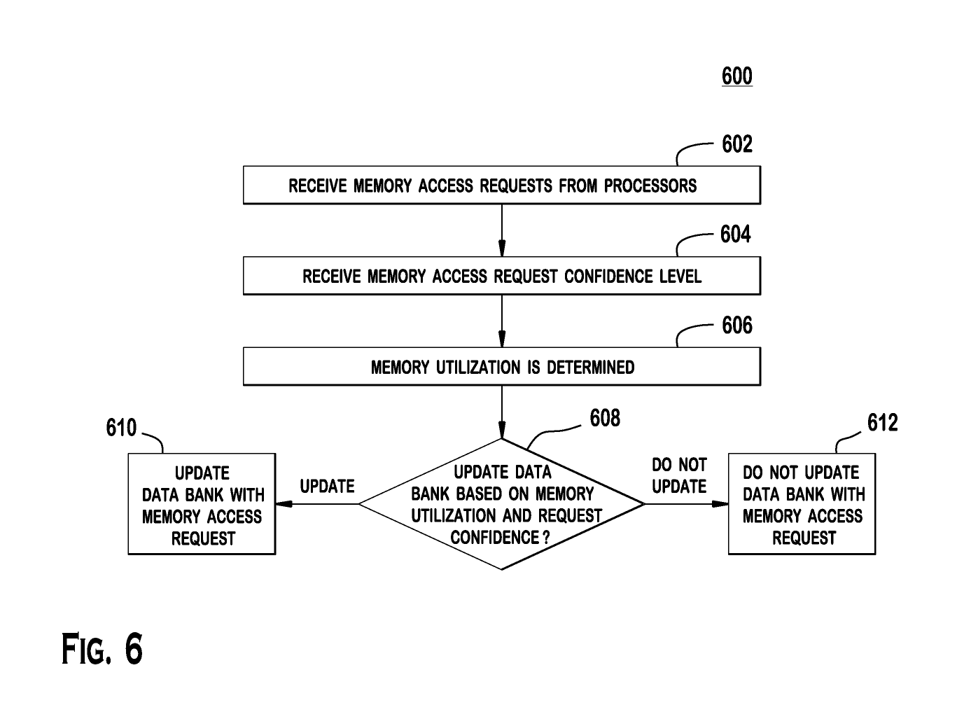

The MS-PFU 150 may determine, according to the level of the system memory 170 utilization, whether to update its data bank 252 with a memory access request from a processor 110 based on the type and confidence level of the request. For instance, if memory utilization is very low, then an MS-PFU 150 can afford to be speculative in its prefetching and may update its data bank 252 with any request, regardless of type or confidence level, thereby resulting in the generation of comparatively speculative prefetch requests by the MS-PFU 150. However, as memory utilization increases, the MS-PFU 150 seeks to reduce its rather speculative prefetching and may update its data bank 252 with only demand requests and high confidence prefetch requests, disregarding medium confidence prefetch requests. As memory utilization increases even more, the MS-PFU 150 may update its data bank 252 with only demand requests and thereby ignore all prefetch requests from the processors 110 in order to reduce its own utilization of memory access resources and reduce the number of speculative prefetch requests it issues. Finally, as memory utilization grows to an even higher level, the MS-PFU 150 may choose not to update its data bank 252 with any type of memory access request 502 from the processors 110 in order to reserve memory bandwidth to the processors 110 and further reduce its issuance of prefetch requests. The flow diagram of FIG. 6 illustrates this method 600.

In the method 600, a memory access request from a processor 110 is received 602 and the type and confidence level of the request is also received 604. Memory utilization is determined 606, (i.e., from the scheduler 160). Based on memory utilization and the type and confidence level of the memory access request, it is determined 608 whether to update the data bank 252 with the incoming request. The data bank 252 may be updated 610 with the memory access request, or alternatively, the data bank 252 may not be updated 612 with the memory access request.

In detailing the embodiments described herein, so far the focus has been on the event that a memory access request issued by a processor 110 does not match an already existing entry in the data bank 252. In this event, the MS-PFU 150 must determine whether to replace an existing entry with the new memory access request. However, another instance is likely to occur, where a memory access request arriving from a processor 110 matches an already existing entry in the data bank 252, but the level of confidence associated with the request has changed. In this instance, the MS-PFU 150 must determine whether to update the level of confidence of a memory access request already existing in the data bank 252. Those skilled in the art will recognize that by updating the level of confidence associated with a memory access request that already exists in the data bank 252, the MS-PFU 150 is likely to generate more of its own prefetch requests, thereby increasing the overall number of memory access requests. This is assuming, of course, that the MS-PFU 150 factors in the confidence level associated with memory access requests existing in its data bank 252 in generating prefetch requests. It is worth noting, however, that generally more prefetch requests are generated by MS-PFU 150 as a result of updating the memory access request than only updating the level of confidence associated with an already existing memory access request in data bank 252.

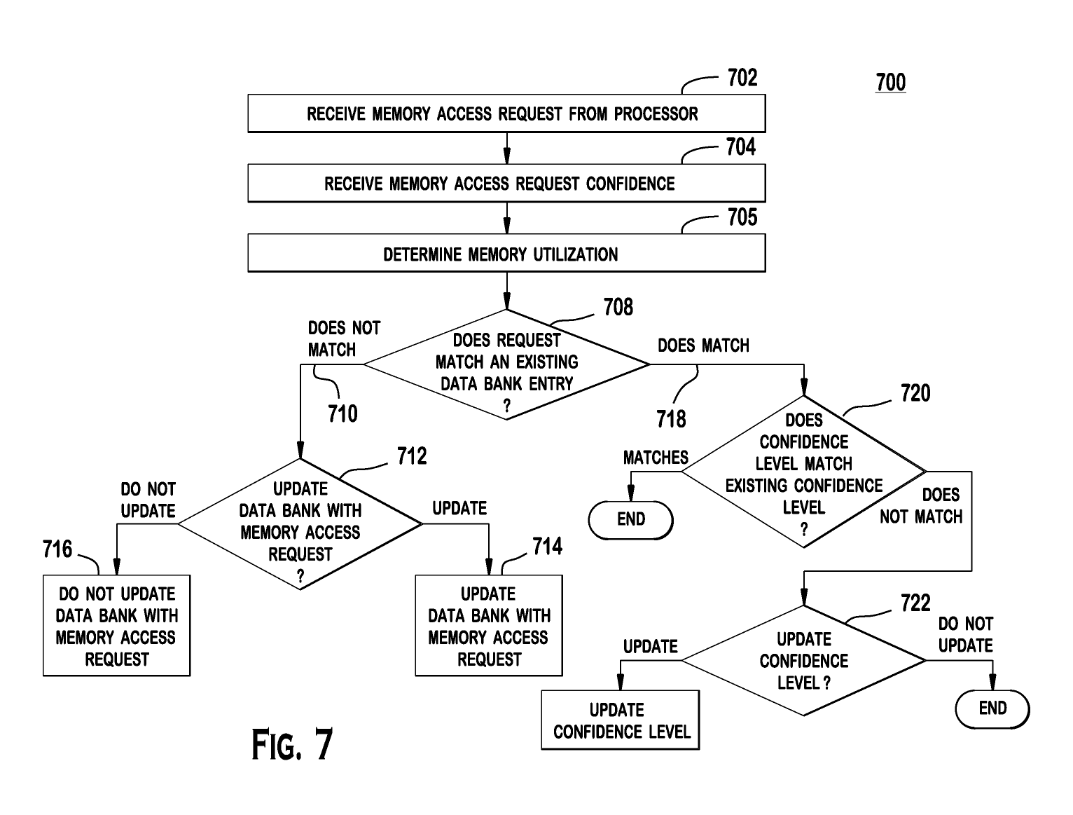

FIG. 7 is a flow diagram of a method 700 that the MS-PFU 150 implements to modulate its behavior based on memory utilization when it receives a memory access request from a processor 110 that matches an already existing entry in the data bank 252, but has a different confidence level. In the method 700, a memory access request from a processor 110 is received 702 and the type and confidence level of the request is also received 704. Memory utilization is determined 706, (i.e., from the scheduler 160). The MS-PFU 150 determines 708 whether the request matches an already existing entry in its data bank 252. If the request does not match 710 an already existing entry in its data bank 252, then the MS-PFU 150 determines whether to update the data bank 252 with the request 712. The data bank 252 may be updated with the memory access request 714 or the data bank may not be updated with the memory access request 716, as previously described in 608-612 in method 600.

If the request does match an existing entry in the data bank 252 718, then it is determined whether the request's confidence level matches the existing confidence level associated with the request 720. If the confidence level matches then no more may be done. If the confidence level does not match the already existing confidence level then it is determined whether to update the confidence level 722, where the confidence level may be updated or not updated if so is determined.

Table 2 shows an embodiment of a decision-based approach an MS-PFU 150 may use in updating its data bank 252 entries. “Y” denotes updating an entry or a confidence level, whereas “N” denotes that the entry or confidence level is not updated. (It is assumed that if a new memory access request matches and has the same confidence level as an existing entry, no action is needed.) The approach described in Table 2 may be used in step 608 in method 600, steps 712 and 722 in method 700, and step 810 in method 800, as will be described shortly.

TABLE 2
MS-PFU 150 training

| | | Non- | |
|---|---|---|---|
| | | matching | Matching |
| Memory | Processor memory access | Update | Update |
| utilization | request | entry | confidence level |
| Very high | Demand | N | N |
| | High Confidence Prefetch | N | N |
| | Medium Confidence Prefetch | N | N |
| High | Demand | Y | Y |
| | High Confidence Prefetch | Y | N |
| | Medium Confidence Prefetch | N | N |
| Medium | Demand | Y | Y |
| | High Confidence Prefetch | Y | Y |
| | Medium Confidence Prefetch | N | N |
| Low | Demand | Y | Y |
| | High Confidence Prefetch | Y | Y |
| | Medium Confidence Prefetch | Y | N |

In Table 2, the MS-PFU 150 is more conservative in updating a memory access request that does not match an existing data bank 252 entry than in updating the level of confidence associated with an already existing data bank 252 entry because updating data bank 252 with a new memory access request will likely result in more prefetch requests by the MS-PFU 150 than only changing the level of confidence associated with an already existing memory access request.

Another layer of modulating the prefetching of an MS-PFU may be utilized. The MS-PFU 150 may also modulate its behavior based on the accuracy of its own prefetch requests. The accuracy of the prefetch requests made by the MS-PFU 150 may be determined by how useful those prefetch requests are in satisfying the demand and prefetch requests of the processors 110. As described herein, the MS-PFU 150 reduces memory access latency by prefetching memory address data ahead of its recall by the processors 110. Therefore, a MS-PFU 150 prefetch request is useful if it is later requested by a processor 110 as a demand request or by a PS-PFU 120 as a prefetch request. However, a MS-PFU 150 prefetch request is not useful if it is not later requested by a processor 110 as a demand request or a PS-PFU 120 as a prefetch request. Therefore, MS-PFU 150 accuracy may be determined as the percentage of its prefetch requests that are used to satisfy a memory access request by the processors 110.

The MS-PFU 150 may place its prefetch requests in a memory-side buffer, (not shown in FIG. 3), where these requests remain until they are used to satisfy a memory access request by the processors 110 or until they are replaced by other requests. Therefore, the MS-PFU 150 may determine the percentage of its requests that are useful to the processors by comparing the proportion of MS-PFU prefetch requests that are used to satisfy demand or prefetch requests by the processors 110 to the total number of MS-PFU 150 prefetch requests. For instance, if over 60% of its prefetch requests are useful then the MS-PFU 150 may be deemed highly accurate, if between 30% to 60% of its prefetch requests are useful then the MS-PFU 150 is deemed to have medium accuracy, and if less than 30% of its prefetch requests are useful then the MS-PFU 150 is deemed to have low accuracy.

Memory utilization is, in part, a function of the prefetch accuracy of the MS-PFU 150. If the MS-PFU 150 is, for example, 0% accurate, it will only generate extra memory access requests that increase memory utilization, while not helping to satisfy the demand and prefetch requests of the processors 110. Conversely, if the MS-PFU 150 is 100% accurate, it will reduce the system memory access latency and will not increase memory utilization because all of its prefetch requests will satisfy demand and prefetch requests by the processors 110 before these processor requests reach the system memory 170.

Because of this correlation, the MS-PFU 150 may modulate its prefetching behavior based on its own prefetch accuracy by modifying the memory utilization thresholds shown in Table 2. The MS-PFU 150 may redefine what constitutes the memory utilization levels of Table 2 so as to increase or decrease the number of prefetch requests it issues depending on its accuracy. For example, if MS-PFU 150 accuracy is high, the MS-PFU 150 may seek to increase the number of prefetch requests it issues. It can do so by redefining high memory utilization as above 75% memory utilization instead of above 60%, or as represented by 11 or more memory access requests in a memory scheduler queue instead of 9 or more. Conversely, if MS-PFU 150 accuracy is low, then the MS-PFU 150 may seek to decrease the number of prefetch requests it issues. It can do so by redefining high memory utilization as above 45% memory utilization instead of above 60%, or as represented by 7 or more memory access requests in a memory scheduler queue instead of 9 or more. By doing so, the MS-PFU 150 will increase the number of prefetch requests it issues when its own accuracy is high and decrease the number of prefetch requests it issues when its own accuracy is low. Therefore, the MS-PFU 150 may rely on its own prefetch accuracy in modulating its behavior to improve memory utilization.

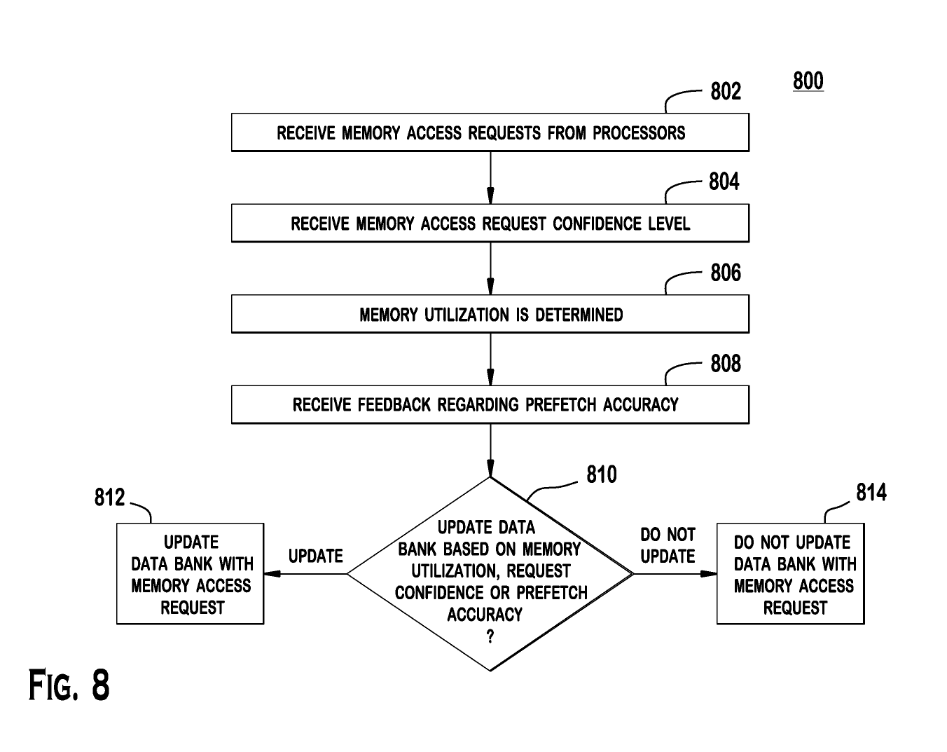

FIG. 8 is a flow diagram of a method 800 that the MS-PFU 150 implements to modulate its behavior according to memory utilization based on its own prefetch accuracy. In the method 800, a memory access request from a processor 110 is received 802 and the type and confidence level of the request is also received 804. Memory utilization is determined 806, (i.e., from the scheduler 160). The prefetch accuracy of the MS-PFU 150 is also determined 808. Based on the level of its prefetch accuracy, the MS-PFU 150 may redefine 810 the memory utilization thresholds. It is then determined 812 whether to update the data bank 252 with the incoming memory access request or confidence level as previously described in method 700 and Table 2. The data bank 252 may be updated 814 with the memory access request or confidence level, or alternatively, the data bank 252 may not be updated 816 with the memory access request or confidence level.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method for handling memory access interaction between a processor and a memory-side prefetch unit (MS-PFU), the method comprising:
training a second memory access unit using a memory access request from a first memory access unit based on memory utilization.

2. The method of claim 1 further comprising:
receiving a first memory access request from a first memory access unit; and
receiving information relating to memory utilization.

3. The method of claim 1 further comprising:
receiving a first memory access request type, wherein the first memory access request type corresponds to the first memory access request; and
determining whether to utilize the first memory access request type in training a second memory access unit based on the first memory access request type.

4. The method of claim 1 further comprising:
determining whether the first memory access request matches an existing training entry of the second memory access unit; and
determining whether to utilize the first memory access request type in training a second memory access unit based on whether the first memory access request matches an existing training entry of the second memory access unit.

5. The method of claim 1 further comprising:
receiving information regarding second memory access unit memory access request accuracy; and
determining whether to utilize the first memory access request in training a second memory access unit based on second memory access unit memory access request accuracy.

6. The method of claim 1 further comprising:
receiving information regarding second memory access unit memory access request accuracy; and
determining whether to utilize the first memory access request type in training a second memory access unit based on second memory access unit memory access request accuracy.

7. The method of claim 1 further comprising:
issuing a memory access request by the second memory access unit.

8. The method of claim 1, wherein the first memory access unit is a processor-side memory access unit.

9. The method of claim 1, wherein the second memory access unit is a memory-side prefetch unit.

10. The method of claim 1, wherein the first memory access request is one of a demand request; or a prefetch request of a particular confidence.

11. The method of claim 1, wherein the memory access request type reveals information regarding one or more of the confidence level associated with the memory access request; or the usefulness of the memory access request.

12. A memory controller comprising:
a prefetch unit configured to train using a memory access request from a first memory access unit based on memory utilization.

13. The memory controller of claim 12 further comprising circuitry configured to receive a first memory access request from a first memory access unit and receive information relating to memory utilization.

14. The memory controller of claim 12 further comprising circuitry configured to receive a first memory access request type, wherein the first memory access request type corresponds to the first memory access request and determine whether to utilize the first memory access request type in training a second memory access unit based on one or more of memory utilization; or the first memory access request type.

15. The memory controller of claim 12 further comprising circuitry configured to determine whether the first memory access request matches an existing training entry of the second memory access unit and determine whether to utilize the first memory access request type in training a second memory access unit based on whether the first memory access request matches an existing training entry of the second memory access unit.

16. The memory controller of claim 12 further comprising circuitry configured to receive information regarding second memory access unit memory access request accuracy and determine whether to utilize the first memory access request in training a second memory access unit based on second memory access unit memory access request accuracy.

17. The memory controller of claim 12 further comprising circuitry configured to receive information regarding second memory access unit memory access request accuracy and determine whether to utilize the first memory access request type in training a second memory access unit based on second memory access unit memory access request accuracy.

18. The memory controller of claim 12 further comprising circuitry configured to issue a memory access request by the second memory access unit.

19. The memory controller of claim 12, wherein the first memory access unit is a processor-side memory access unit.

20. A computer system comprising:
a system memory;
one or more processors; and
a memory controller coupled to the system memory and the one or more processors, wherein the memory controller comprises: a prefetch unit configured to train using a memory access request from a first memory access unit based on memory utilization.

21. The computer system of claim 20 further comprising circuitry configured to receive a first memory access request from a first memory access unit and receive information relating to memory utilization.

22. The computer system of claim 20 further comprising circuitry configured to receive a first memory access request type, wherein the first memory access request type corresponds to the first memory access request and determine whether to utilize the first memory access request type in training a second memory access unit based on one or more of memory utilization; or the first memory access request type.

23. The computer system of claim 20 further comprising circuitry configured to determine whether the first memory access request matches an existing training entry of the second memory access unit and determine whether to utilize the first memory access request type in training a second memory access unit based on whether the first memory access request matches an existing training entry of the second memory access unit.

24. The computer system of claim 20 further comprising circuitry configured to receive information regarding second memory access unit memory access request accuracy and determine whether to utilize the first memory access request in training a second memory access unit based on second memory access unit memory access request accuracy.

25. The computer system of claim 20 further comprising circuitry configured to receive information regarding second memory access unit memory access request accuracy and determine whether to utilize the first memory access request type in training a second memory access unit based on second memory access unit memory access request accuracy.

26. The computer system of claim 20 further comprising circuitry configured to issue a memory access request by the second memory access unit.

27. The computer system of claim 20, wherein the first memory access unit is a processor-side memory access unit.

28. The computer system of claim 20, wherein the first memory access request is one of a demand request; or a prefetch request of a particular confidence.

29. A computer-readable storage medium storing a set of instructions for execution by a general purpose computer to optimize memory access, the set of instructions comprising:
a training code segment for training a second memory access unit using a memory access request from a first memory access unit based on memory utilization.

30. The computer readable storage medium of claim 29, wherein the set of instructions are hardware description language (HDL) instructions used for the manufacture of a device.
